(19) United States
(12) Patent Application Publication
(10) Pub. No.: US 2005/0054241 A1
(43) Pub. Date: Mar. 10, 2005

(54) Multi-jack adapter

(76) Inventor: John Peng, Taipei County (TW)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/916,146

(22) Filed: Aug. 11, 2004

(30) Foreign Application Priority Data
Sep. 10, 2003 (TW) 92216394

(51) Int. Cl. H01R 13/648

(52) U.S. Cl. 439/638

(57) ABSTRACT

A multi-jack adapter for adapting a jack into multiple jacks is provided. The multi-jack adapter includes a plug has a plugging part for being connected to said jack and a plurality of conducting wires; a printed circuit board electrically connected to said jack through welding said plurality of conducting wires; and a first and second golden finger supports set on a connecting surface of said printed circuit board and respectively having a first and a second golden finger surfaces perpendicular to said connecting plane.

### FIELD OF THE INVENTION

The present invention is related to an adapter, and more particularly, to a multi-jack adapter for adapting a jack into multiple jacks. The multi-jack adapter includes a plug, a printed circuit board and a first and second golden finger supports. The present invention provides a multi-jack adapter having a more convenient circuit and electrical connection on the printed circuit board.

### BACKGROUND OF THE INVENTION

The one-to-two adapter fitting the performance of C5 or C6 in the market usually is a T-Modular adapter. However, the inner circuit in the print circuit board of a T-Modular adapter is complex. Please refer to FIG. 1. FIG. 1 is a schematic diagram of a one-to-two adapter according to the prior art. The two-jack adapter 10 (T-MOD3) shown in FIG. 1 is made by Telebox industrial company. The two-jack adapter 10 has a wire 11 connected with a plug 12 for adapting a jack into two jacks 13, 14. Inside the two jacks 13, 14, a printed circuit board is usually disposed above the two jacks 13, 14. Particularly, the circuit wire of the printed circuit board is wired on both sides of the printed circuit board. This not only causes the difficulty of wiring, but also generates interference between the wires, especially when the transmitting rate of the signals are higher and the signals transmitted through the wires at two sides of the printed circuit board are too close.

Please refer to FIG. 2. FIG. 2 is a schematic diagram of another one-to-two adapter according to the prior art. The two-jack adapter 20 (TA2008) includes a plug 21 and an integrally-made two jacks 22, 23. Although the volume is smaller, the interference problem is not solved since the circuit of the printed circuit board is still wired on both sides of the printed circuit board.

From the above, it is known that how to increase the convenience for wiring the circuit on the printed circuit board and solve the interference problem caused by the too-close wiring on both sides of the printed circuit board have become a major problem waited to be solved in the industry. Therefore, a multi-jack adapter is provided in the present invention.

### SUMMARY OF THE INVENTION

The main purpose of the present invention is to provide a multi-jack adapter, in which the positions of the plug and the jacks are not parallel to each other, but have an included angle therebetween.

It is another object of the present invention to provide a multi-jack adapter, in which a first and second golden finger supports are set perpendicularly to the printed circuit board. That is, the first and second golden finger surfaces of the first and second golden finger supports are perpendicular to the printed circuit board.

According to another object of the present invention, a plurality of conducting wires are welded on the connecting surface of the printed circuit board and form a first and second rows of welding wires on the connecting surface.

According to a further object of the present invention, all the circuits are wired on one side of the printed circuit board so as to reduce the interference between close wires when the signals are transmitted.

According to one aspect of the present invention, a multi-jack adapter for adapting a jack into multiple jacks includes a plug having a plugging part for being connected to the jack and a plurality of conducting wires, a printed circuit board electrically connected to the plug through welding the plurality of conducting wires thereon and a first and second golden finger supports set on a connecting surface of the printed circuit board and respectively having a first and a second golden finger surfaces perpendicular to the connecting surface.

In accordance with the present invention, a plurality of conducting wires are welded on the connecting surface of the printed circuit board and the first and second golden finger supports are connected to the connecting surface through a first and second inner lateral surfaces respectively thereof.

Preferably, a plurality of conducting wires welded on the connecting surface form a first and second rows of welding wires for being electrically connected to the first and second golden finger supports through a first and second circuits on the printed circuit board.

Preferably, the first and second circuits are both disposed on a circuit surface of the printed circuit board which is opposite to the connecting surface.

Preferably, the first and second golden finger supports respectively have a first and second converting wires for converting a transmitting signal of the plurality of conducting wires to one of the first and second golden finger supports.

Preferably, the first and second converting wires respectively have a first and second fixing terminals for being welded on the circuit surface of the printed circuit board.

According to another aspect of the present invention, a multi-jack adapter for adapting a jack into multiple jacks includes a plug having a plugging part for being connected to the jack and a plurality of conducting wires, a printed circuit board electrically connected to the plug through welding the plurality of conducting wires thereon, and a first and second golden finger supports set on a connecting surface of the printed circuit board and respectively having a first and a second golden finger surfaces which respectively have an included angle with the connecting surface.

In accordance with the present invention, the angle is 90 degree.

Preferably, a plurality of conducting wires are welded on the connecting surface of the printed circuit board and the first and second golden finger supports are connected to the connecting surface through a first and second inner lateral surfaces respectively thereof.

Preferably, a plurality of conducting wires welded on the connecting surface form a first and second rows of welding wires for being electrically connected to the first and second golden finger supports through a first and second circuits on the printed circuit board.

Preferably, the first and second circuits are both disposed on a circuit surface of the printed circuit board which is opposite to the connecting surface.

Preferably, the first and second golden finger supports respectively have a first and second converting wires for converting a transmitting signal of the plurality of conducting wires to one of the first and second golden finger supports.

Preferably, the first and second converting wires respectively have a first and second fixing terminals for being welded on the circuit surface of the printed circuit board.

According to another aspect of the present invention, a multi-jack adapter includes a plug having a plugging part and a plurality of conducting wires, a printed circuit board electrically connected to the plug through welding the plurality of conducting wires thereon, and a first and second golden finger supports set on a connecting surface of the printed circuit board and respectively having a first and a second golden finger surfaces perpendicular to the connecting surface.

In accordance with the present invention, the adapter is employed to adapt a jack into multiple jacks and the plug is employed to be plugged into the jack.

Preferably, a plurality of conducting wires are welded on the connecting surface of the printed circuit board and the first and second golden finger supports are connected to the connecting surface through a first and second inner lateral surfaces respectively thereof.

Preferably, a plurality of conducting wires welded on the connecting surface form a first and second rows of welding wires for being electrically connected to the first and second golden finger supports through a first and second circuits on the printed circuit board.

Preferably, the first and second circuits are both disposed on a circuit surface of the printed circuit board which is opposite to the connecting surface.

Preferably, the first and second golden finger supports respectively have a first and second converting wires for converting a transmitting signal of the plurality of conducting wires to one of the first and second golden finger supports.

Preferably, the first and second converting wires respectively have a first and second fixing terminals for being welded on the circuit surface of the printed circuit board.

The foregoing and other features and advantages of the present invention will be more clearly understood through the following descriptions with reference to the drawings, wherein:

### BRIEF DESCRIPTION OF THE DRAWINGS

FIG. 1 is a schematic diagram of an one-to-two adapter according to the prior art;

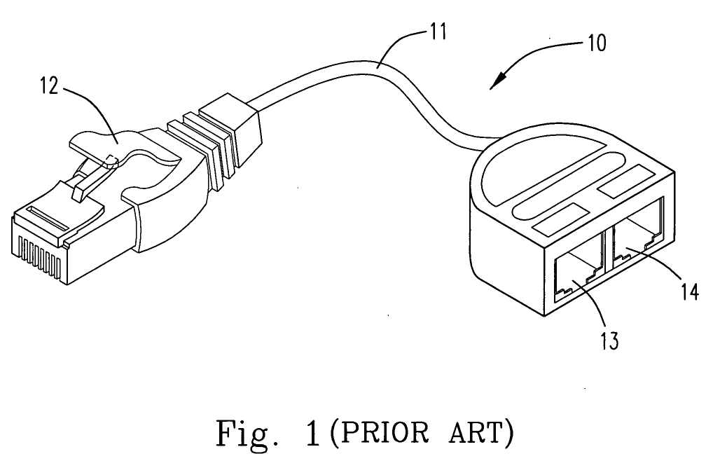

FIG. 2 is a schematic diagram of another one-to-two adapter according to the prior art;

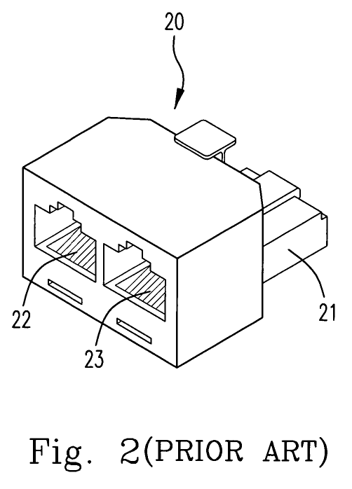

FIG. 3 is a diagram of the structure of an one-to-two adapter according to a preferred embodiment of the present invention;

FIG. 4 is a sectional diagram of the structure of an one-to-two adapter according to a preferred embodiment of the present invention; and

FIG. 5 is a bottom view of the structure of an one-to-two adapter according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

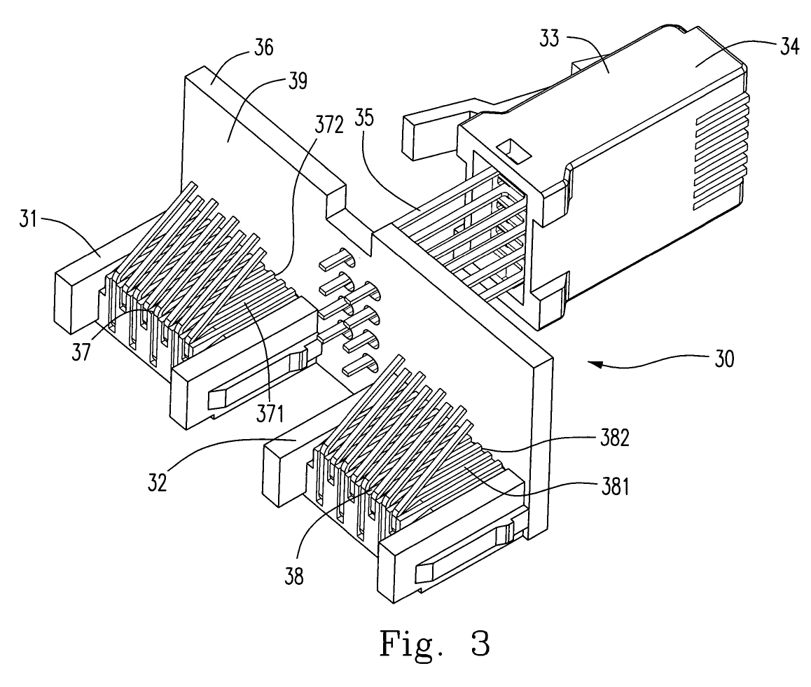

Please refer to FIG. 3. FIG. 3 is a diagram of the structure of an one-to-two adapter 30 according to a preferred embodiment of the present invention. The one-to-two adapter 30 adapts a jack (not shown) into multiple jacks 31, 32. The structure of the one-to-two adapter 30 mainly includes a plug 33, a printed circuit board 36, a first golden finger support 37, and a second golden finger support 38. The plug 33 has a plugging part 34 for being connected to the jack (not shown). The plug 33 further has a plurality of conducting wires 35. The printed circuit board 36 is electrically connected to the plug 33 through welding the plurality of conducting wires 35 thereon. The first golden finger support 37 and the second golden finger support 38 are set on a connecting surface 39 of the printed circuit board 36 and respectively have a first golden finger surface 371 and a second golden finger surface 381 perpendicular to the connecting surface 39.

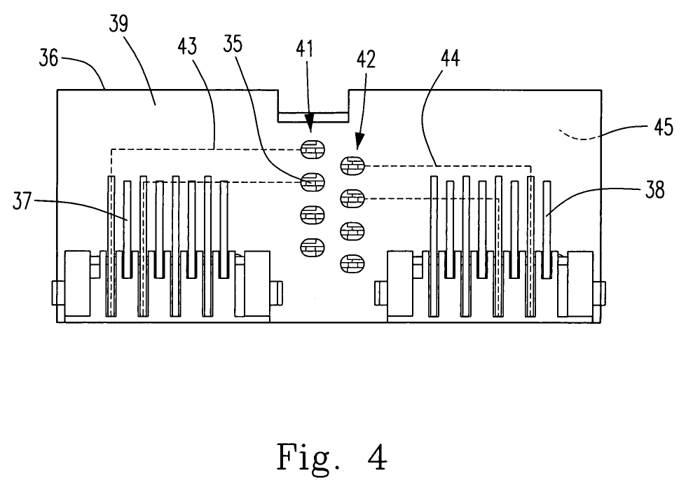

The plurality of conducting wires 35 are welded on the connecting surface 39 of the printed circuit board 36. The first and second golden finger supports 37, 38 are connected to the connecting surface 39 respectively through a first inner lateral surface 372 and a second inner lateral surface 382 thereof. Please refer to FIG. 4. FIG. 4 is a sectional diagram of the structure of an one-to-two adapter according to a preferred embodiment of the present invention. The plurality of conducting wires 35 welded on connecting surface 39 form a first row of welding wire 41 and a second row of welding wire 42. In addition, the plurality of conducting wires 35 are electrically connected to the first and second golden finger supports 37, 38 through a first circuit 43 and a second circuit 44 on the printed circuit board 36. The first and second circuits 43, 44 are both disposed on a circuit surface 45 of the printed circuit board 36. The circuit surface 45 is opposite to the connecting surface 39.

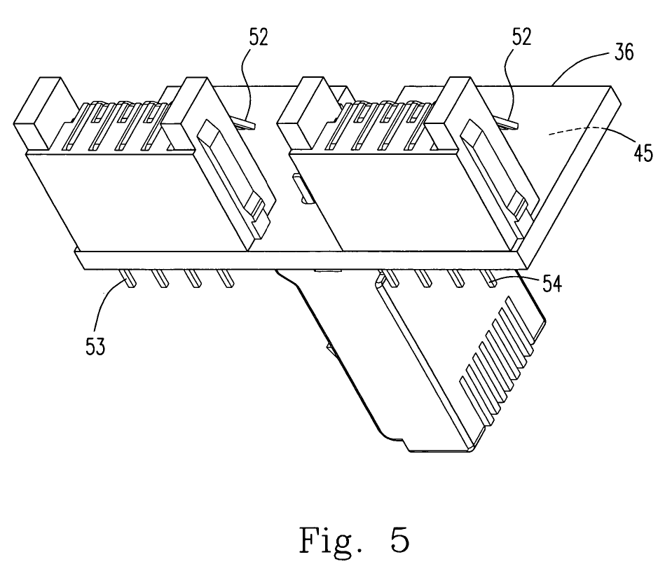

Please refer to FIG. 5. FIG. 5 is a bottom view of the structure of an one-to-two adapter according to a preferred embodiment of the present invention. The first and second golden finger supports 37, 38 respectively have a first converting wire 51 and a second converting wire 52 for converting a transmitting signal of the plurality of conducting wires 35 to the first finger support 37 or to the second golden finger support 38. The first and second converting wires 51, 52 respectively have a first fixing terminal 53 and a second fixing terminal 54 for being welded on the circuit surface 45 of the printed circuit board 36.

According to another aspect of the present invention, the one-to-two adapter 30 adapts a jack (not shown) into multiple jacks 31, 32. The structure of the one-to-two adapter 30 mainly includes a plug 33, a printed circuit board 36, a first golden finger support 37, and a second golden finger support 38. The plug 33 has a plugging part 34 for being connected to the jack (not shown). The plug 33 further has a plurality of conducting wires 35. The printed circuit board 36 is electrically connected to the plug 33 through welding the plurality of conducting wires 35 thereon. The first golden finger support 37 and the second golden finger support 38 are set on a connecting surface 39 of the printed circuit board 36. Further, the first and second golden finger supports 37, 38 respectively have a first golden finger surface 371 and a second golden finger surface 381 which respectively have an included angle with the connecting surface 39. Preferably, the angle between the connecting surface 39 and the first and second golden finger surfaces 371, 381 is 90 degree. Certainly, the angle between the connecting surface 39 and the first and second golden finger surfaces 371, 381 is not limited to 90 degree. With regard to other structural features, they are not repeatedly described here since they have been discussed in the above.

According to another aspect of the present invention, a multi-jack adapter is provided. The structure of the one-to-two adapter 30 mainly includes a plug 33, a printed circuit board 36, a first golden finger support 37, and a second golden finger support 38. The plug 33 has a plugging part 34 for being connected to the jack (not shown). The plug 33 further has a plurality of conducting wires 35. The printed circuit board 36 is electrically connected to the plug 33 through welding the plurality of conducting wires 35 thereon. The first golden finger support 37 and the second golden finger support 38 are set on a connecting surface 39 of the printed circuit board 36 and respectively have a first golden finger surface 371 and a second golden finger surface 381 perpendicular to the connecting surface 39. Preferably, the adapter 30 is employed to adapt a jack into multiple jacks 31, 32 and the plug 33 is employed to be plugged into the jack. Certainly, the adapter 30 is not limited to adapt a jack into multiple jacks. With regard to other structural features, they are not repeatedly described here since they have been discussed in the above.

According to the above, the first golden finger support 37 and the second golden finger support 38 are set on the printed circuit board 36 and perpendicular to the printed circuit board 36. As such, the first and second golden finger surfaces 371, 381 are perpendicular to the printed circuit board 36. In addition, the plurality of conducting wires are welded on the connecting surface of the printed circuit board and form a first and second rows of welding wires on the connecting surface. All the circuits are wired on one side of the printed circuit board so as to reduce the interference between close wires when the signals are transmitted. Therefore, a multi-jack adapter provided in the present invention has very suitable for industrial production. Hence, the present invention not only has a novelty and a progressive nature, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A multi jack adapter for adapting a jack into multiple jacks, comprising:
a plug having a plugging part for being connected to said jack and a plurality of conducting wires;
a printed circuit board electrically connected to said plug through welding said plurality of conducting wires thereon; and
a first and second golden finger supports set on a connecting surface of said printed circuit board and respectively having a first and a second golden finger surfaces perpendicular to said connecting surface.

2. The multi-jack adapter according to claim 1, wherein said plurality of conducting wires are welded on said connecting surface of said printed circuit board and said first and second golden finger supports are connected to said connecting surface through a first and second inner lateral surfaces respectively thereof.

3. The multi-jack adapter according to claim 2, wherein said plurality of conducting wires welded on said connecting surface form a first and second rows of welding wires for being electrically connected to said first and second golden finger supports through a first and second circuits on said printed circuit board.

4. The multi-jack adapter according to claim 3, wherein said first and second circuits are both disposed on a circuit surface of said printed circuit board which is opposite to said connecting surface.

5. The multi-jack adapter according to claim 4, wherein said first and second golden finger supports respectively have a first and second converting wires for converting a transmitting signal of said plurality of conducting wires to one of said first and second golden finger supports.

6. The multi-jack adapter according to claim 5, wherein said first and second converting wires respectively have a first and second fixing terminals for being welded on said circuit surface of said printed circuit board.

7. A multi-jack adapter for adapting a jack into multiple jacks, comprising:
a plug having a plugging part for being connected to said jack and a plurality of conducting wires;
a printed circuit board electrically connected to said plug through welding said plurality of conducting wires thereon; and
a first and second golden finger supports set on a connecting surface of said printed circuit board and respectively having a first and a second golden finger surfaces which respectively have an included angle with said connecting surface.

8. The multi-jack adapter according to claim 7, wherein said angle is 90 degree.

9. The multi-jack adapter according to claim 7, wherein said plurality of conducting wires are welded on said connecting surface of said printed circuit board and said first and second golden finger supports are connected to said connecting surface through a first and second inner lateral surfaces respectively thereof.

10. The multi-jack adapter according to claim 9, wherein said plurality of conducting wires welded on said connecting surface form a first and second rows of welding wires for being electrically connected to said first and second golden finger supports through a first and second circuits on said printed circuit board.

11. The multi-jack adapter according to claim 10, wherein said first and second circuits are both disposed on a circuit surface of said printed circuit board which is opposite to said connecting surface.

12. The multi-jack adapter according to claim 11, wherein said first and second golden finger supports respectively have a first and second converting wires for converting a transmitting signal of said plurality of conducting wires to one of said first and second golden finger supports.

13. The multi-jack adapter according to claim 12, wherein said first and second converting wires respectively have a first and second fixing terminals for being welded on said circuit surface of said printed circuit board.

14. A multi-jack adapter comprising:
a plug having a plugging part and a plurality of conducting wires;
a printed circuit board electrically connected to said plug through welding said plurality of conducting wires thereon; and
a first and second golden finger supports set on a connecting surface of said printed circuit board and respectively having a first and a second golden finger surfaces perpendicular to said connecting surface.

15. The multi-jack adapter according to claim 14, wherein said adapter is employed to adapt a jack into multiple jacks and said plug is employed to be plugged into said jack.

16. The multi-jack adapter according to claim 14, wherein said plurality of conducting wires are welded on said connecting surface of said printed circuit board and said first and second golden finger supports are connected to said connecting surface through a first and second inner lateral surfaces respectively thereof.

17. The multi-jack adapter according to claim 16, wherein said plurality of conducting wires welded on said connecting surface form a first and second rows of welding wires for being electrically connected to said first and second golden finger supports through a first and second circuits on said printed circuit board.

18. The multi-jack adapter according to claim 17, wherein said first and second circuits are both disposed on a circuit surface of said printed circuit board which is opposite to said connecting surface.

19. The multi-jack adapter according to claim 18, wherein said first and second golden finger supports respectively have a first and second converting wires for converting a transmitting signal of said plurality of conducting wires to one of said first and second golden finger supports.

20. The multi-jack adapter according to claim 19, wherein said first and second converting wires respectively have a first and second fixing terminals for being welded on said circuit surface of said printed circuit board.
